(19) United States
(12) Patent Application Publication
(10) Pub. No.: US 2026/0203494 A1
(43) Pub. Date: Jul. 16, 2026

(54) Systems, Methods and Computer-Readable Media for Categorising Information from a Visual Representation of Data

(71) Applicant: Xero Limited, Te Aro, Wellington (NZ)

(72) Inventor: Bryan Obright, Te Aro, Wellington (NZ)

(21) Appl. No.: 19/129,989

(22) PCT Filed: Nov. 17, 2023
(86) PCT No.: PCT/NZ2023/050134

§ 371 Date: May 14, 2025

(30) Foreign Application Priority Data
Nov. 18, 2022 (AU) 2022903492

(51) Int. Cl. G06F 40/169; G06F 40/177

(52) U.S. Cl. CPC G06F 40/169; G06F 40/177

(57) ABSTRACT

A method comprises presenting a display object comprising a visual representation of a plurality of data items, the plurality of data items being arranged in a tabular form. In response to a user input, received via the user interface, applying a context annotation to the display object, the method comprises determining, based on the context annotation, at least one selected data item of the plurality of data items, determining a first data category associated with the selected data item, determining, based on a position of the selected data item in the tabular form, a second data item of the plurality of data items, and associating a second data category to the second data item, based on the first data category.

### CROSS-REFERENCE TO RELATED APPLICATION(S)

This application is a national stage 371 application of International Patent Serial No. PCT/NZ2023/050134, filed on Nov. 17, 2023, which claims priority to and the benefit of Australian Patent Application Serial No. 2022903492, filed Nov. 18, 2022, the entire disclosures of which are hereby incorporated by reference.

### TECHNICAL FIELD

Embodiments generally relate to systems, methods and computer-readable media for categorising information from a visual representation of data. In particular, embodiments relate to user-assisted categorisation of information from a visual representation of alpha-numeric data.

### BACKGROUND

Manually reviewing physical documents, or virtual documents that do not contain machine-encoded text, to extract and categorise information from them can be a time-intensive, arduous and error-prone process. For example, a financial document may need to be visually inspected by a human to extract and categorise specific data items from the document. After the visual inspection, the categorised data items may need to be manually entered into a computer system to provide the computer with machine-encoded information. Such data entry processes are often prone to human error. Significant time and resources may be expended to ensure that complete and accurate data entry has been performed.

It is desired to address or ameliorate one or more shortcomings or disadvantages associated with such prior art, or to at least provide a useful alternative hereto.

Throughout this specification the word ‘comprise’, or variations such as ‘comprises’ or ‘comprising’, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY

Systems and methods provided provide for the user-assisted categorisation of information from a visual representation of alpha-numeric data.

According to one aspect, there is provided a method comprising presenting, on a display device, a user interface, presenting, in the user interface, a display object comprising a visual representation of a plurality of data items, the plurality of data items being arranged in a tabular form, and in response to a user input, received via the user interface, applying a context annotation to the display object. The method further comprises determining, based on the context annotation, at least one selected data item of the plurality of data items, determining a first data category associated with the selected data item, determining, based on a position of the selected data item in the tabular form, a second data item of the plurality of data items, and associating a second data category to the second data item, based on the first data category.

In some embodiments, determining at least one selected data item of the plurality of data items comprises determining a position of the context annotation on the display object, and selecting the at least one selected data item based on the position of the context annotation on the display object.

In some embodiments, determining at least one selected data item of the plurality of data items comprises determining a distance between the context annotation and the selected data item.

In some embodiments, the context annotation at least partially intersects the at least one selected data item, and/or encompasses, or substantially encompasses the at least one selected data item.

In some embodiments, determining a second data item of the plurality of data items comprises determining a row of the tabular form associated with the selected data item, and selecting the second data item from a set of data items positioned in the row.

In some embodiments, determining a second data item of the plurality of data items comprises determining a column of the tabular form associated with the selected data item; and selecting the second data item from a set of data items positioned in the column.

In some embodiments, the method further comprises visually annotating the display object with a categorisation indication to indicate a data categorisation for the selected data item.

In some embodiments, the categorisation indication comprises a continuous or non-continuous line spatially associated with the selected data item, a visual mark spatially associated with the selected data item, and/or a visual effect applied to the selected data item.

In some embodiments, the method further comprises, in response to a second user input, received via the user interface, applying a second context annotation to the display object, determining, based on the second context annotation, a third selected data item of the plurality of data items, and determining a third data category associated with the third selected data item. In some embodiments, associating the second data category to the second data item comprises, associating the second data category to the second data item based on the first data category and the third data category.

In some embodiments, the display object comprises non-machine encoded representations of the plurality of data items.

In some embodiments, the method further comprises determining, by a character recognition module the plurality of data items from the display object.

In some embodiments, the method further comprises determining, by the character recognition module, machine-encoded text for each data item of the plurality of data items.

In some embodiments, the method further comprises determining a tabular form of the plurality of data items.

In some embodiments, determining a tabular form comprises, for each data item of the plurality of data items, determining a row and a column associated with the data item.

In some embodiments, the method further comprises annotating the display object with a tabular form indication to visually indicate the tabular form of the plurality of data items.

In some embodiments, the tabular form indication comprises visual delineations of the rows and columns associated with the plurality of data items.

In some embodiments, the method further comprises, in response to receiving a user input indicating an adjustment to the tabular form determining an adjusted tabular form, and annotating the display object to visually indicate the adjusted tabular form.

In some embodiments, the context annotation spatially intersects the selected data item on the display object.

In some embodiments, the context annotation comprises a continuous or non-continuous line, a continuous or non-continuous perimeter of a two-dimensional shape, a continuous or non-continuous line that encompasses the visual representation of one or more data items of the plurality of data items, and/or a continuous or non-continuous line that substantially encompasses the visual representation of one or more data items of the plurality of data items.

In some embodiments, the first data category comprises a user-selected data category.

In some embodiments, the method further comprises providing a prompt, via the user interface, to prompt the user to annotate the display object in accordance with the first data category.

In some embodiments, the prompt comprises an indication of the first data category.

In some embodiments, the second data item comprises a plurality of second data items.

In some embodiments, the plurality of second data items are positioned within a column of the tabular form of the plurality of data items

In some embodiments, the plurality of second data items are positioned within a row of the tabular form of the plurality of data items.

In some embodiments, the display object comprises a financial statement, or part thereof.

In some embodiments, the plurality of data items comprise one or more of posted date, transaction date, vendor name, transaction amount, deposit amount, withdrawal amount, total amount, balance amount, and/or other financial data.

In some embodiments, the method further comprises, in response to a user input, received via the user interface, applying a predicted data categorisation to the display object.

According to another aspect, there is provided a computer-implemented method comprising presenting, on a display device, a user interface, presenting, in the user interface, a display object comprising a visual representation of a plurality of data items, the plurality of data items being arranged in a tabular form, and in response to a user input, received via the user interface, applying a context annotation to the display object. The computer-implemented method further comprises determining, based on the context annotation, at least one selected data item of the plurality of data items, determining a first data category associated with the selected data item, determining, based on a position of the selected data item in the tabular form, a second data item of the plurality of data items, and associating a second data category to the second data item, based on the first data category.

According to another aspect, there is provided a computer-implemented method comprising presenting, on a display device, a user interface, and presenting, in the user interface, a display object comprising a visual representation of a plurality of data items. The method further comprises determining an alpha-numeric value of at least one data item of the plurality of data items and determining a set of data categories associated with the display object. The method further comprises categorising the at least one data item with a data category of the plurality of data categories, and in response to categorising the data item with the data category, applying a visual indicator to the data item. In some embodiments, the visual indicator indicates the data category of the data item.

In some embodiments, the method further comprises, determining an alpha-numeric value of a second data item of the plurality of data items, categorising the second data item with a second data category of the plurality of data categories, and in response to categorising the second data item with the second data category, applying a second visual indicator to the second data item, wherein the second visual indicator visually differs from the visual indicator.

In some embodiments, the set of data categories comprises a first data category and a second data category. In some embodiments, the method further comprises, in response to categorising the data item with a first category, apply a first visual indicator to the data item in the display object, and in response to categorising the data item with a second category, apply a second visual indicator to the data item in the display object, wherein the first visual indicator has a different visual appearance to the second visual indicator. In some embodiments, a subset of data items of the plurality of data items comprises a representation of a financial transaction.

In some embodiments, the method further comprises, in response to determining a respective category for each data item of the subset of data items, applying a respective visual indicator to each data item of the subset of data items, wherein the respective visual indicators share a common visual attribute. In some embodiments, the method further comprises, in response to determining a respective category for each data item of the subset of data items, applying a single visual indicator to all data items of the subset of data items.

In some embodiments, the method further comprises, receiving, via the user interface, a context annotation applied to a third data item of the plurality of data items, and determining, based on the context annotation, a third data category of the set of data categories. In some embodiments, the method further comprises, applying a third visual indicator to the third data item, the third visual indicator being associated with the data category.

In some embodiments, the plurality of data items are arranged in a tabular form.

In some embodiments, the method further comprises, in response to determining that a fourth data item of the plurality of data items has not been extracted, apply a fourth visual indicator, the fourth visual indicator visually differs from the visual indicator.

In some embodiments, the method further comprises, in response to receiving, via the user interface, a selection of the data item, display an indication of the category of the data item. In some embodiments, the selection of the data item comprises one or more of: a mouse-click on the data item; a mouse-over of the data item; and a touch of a data item. In some embodiments, the indication of the category of the data item comprises a mouse pointer tag.

According to another aspect, there is provided a system comprising one or more processors, and memory comprising computer executable instructions, which when executed by the one or more processors, cause the system to perform the method of any one of the claims.

According to another aspect, there is provided a machine-readable storage medium storing instructions which, when executed by one or more processors, cause the one or more processors to perform the method of any one of claims.

### BRIEF DESCRIPTION OF THE DRAWINGS

The invention will now be described with reference to the accompanying drawings, in which:

FIG. 1 is a block diagram of a system for determining a data category for a data item displayed in a display object on a user interface of a client device, according to an embodiment;

FIG. 2 is a block diagram of a graphical user interface, according to an embodiment;

FIG. 3 is a process flow diagram of a method performed by an application to categorise data items based on user-provided context annotations, according to an embodiment;

FIG. 4 illustrates a display object as displayed on the graphical user interface of the client device, according to an embodiment;

FIG. 5 illustrates the display object of FIG. 4, annotated with lines representing the tabular form of the data items, according to an embodiment;

FIG. 6 illustrates the a display object of FIG. 4, annotated by the user, via interaction with the user interface, according to an embodiment;

FIG. 7 illustrates the display object of FIG. 4 annotated by the application with lines representing a consolidated tabular form of the data items, according to an embodiment;

FIG. 8 illustrates the display object of FIG. 7 which has been further annotated by the application in response to receiving user input from the user, according to an embodiment;

FIG. 9 illustrates the display object of FIG. 7 which has been further annotated by the application, according to an embodiment;

FIG. 10 illustrates a display object in which the application determines data item categorisations based on user-indicated data categorisations, according to an embodiment;

FIG. 11 illustrates a display object which has been annotated by the application to indicate the tabular form of the data items, as determined by the application, according to an embodiment;

FIG. 12 illustrates the display object of FIG. 11 which has been annotated by the application in response to receiving context indication from the user, according to an embodiment;

FIG. 13 illustrates the display object of FIG. 11 at a point in time at which the user is applying a context annotation, according to an embodiment; and

FIG. 14 is a process flow diagram of a method to visually indicate data items that have been extracted and categorised, according to an embodiment;

FIG. 15 illustrates a display object to which the application has applied visual indicators to indicate extracted data items associated with a transaction, according to an embodiment;

FIG. 16 illustrates a display object to which the application has applied visual indicators to indicate the categories of extracted data items, according to an embodiment; and

FIG. 17 illustrates a display object to which the application has applied visual indicators to indicate the categories of extracted data items, according to an embodiment.

Various ones of the appended drawings merely illustrate example embodiments of the present disclosure and cannot be considered as limiting its scope.

### DETAILED DESCRIPTION

Embodiments generally relate to systems, methods and computer-readable media for user-assisted categorisation of data presented in a display object that comprises a plurality of data items arranged in a tabular form.

Embodiments provide for a user to input context information for a subset of the data items displayed in the display object, and in light of the user-provided context information for a subset of the data items, embodiments provide for the inferred categorisation of other data items displayed in the display object. Accordingly, embodiments obviate the need for the user to categorise each data item displayed in the display object. Advantageously, embodiments allow for the detection and classification of tabulated data items with less user interaction.

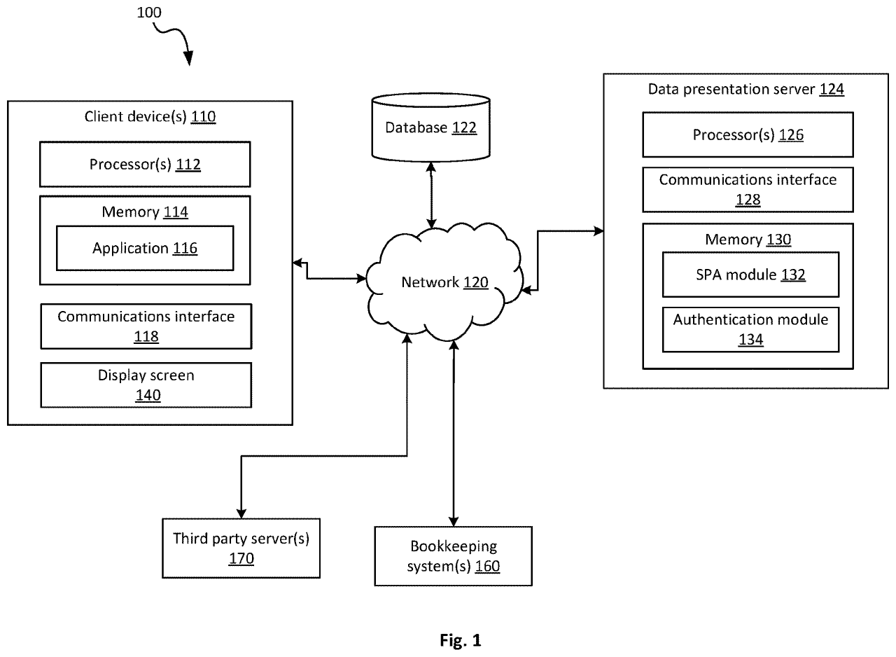

### FIG. 1—System Block Diagram

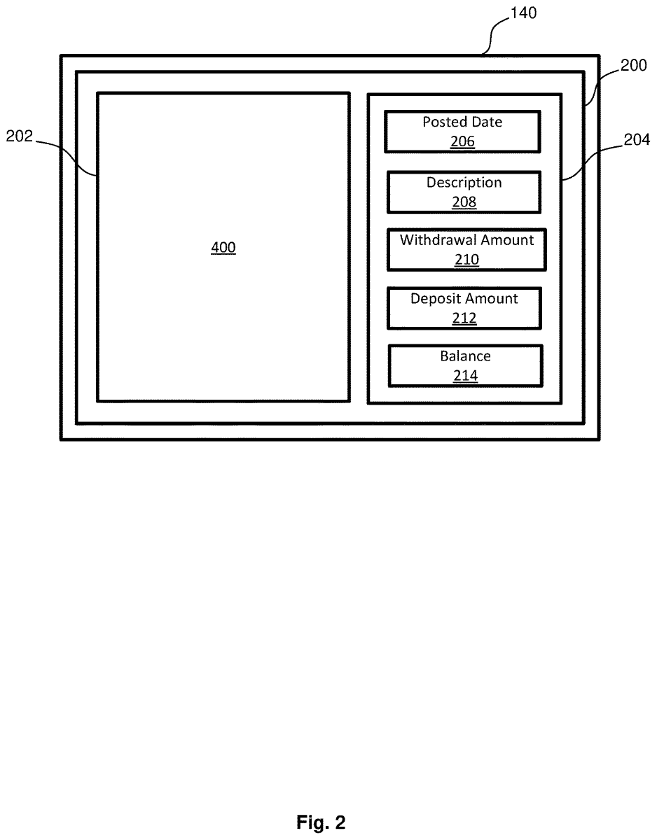

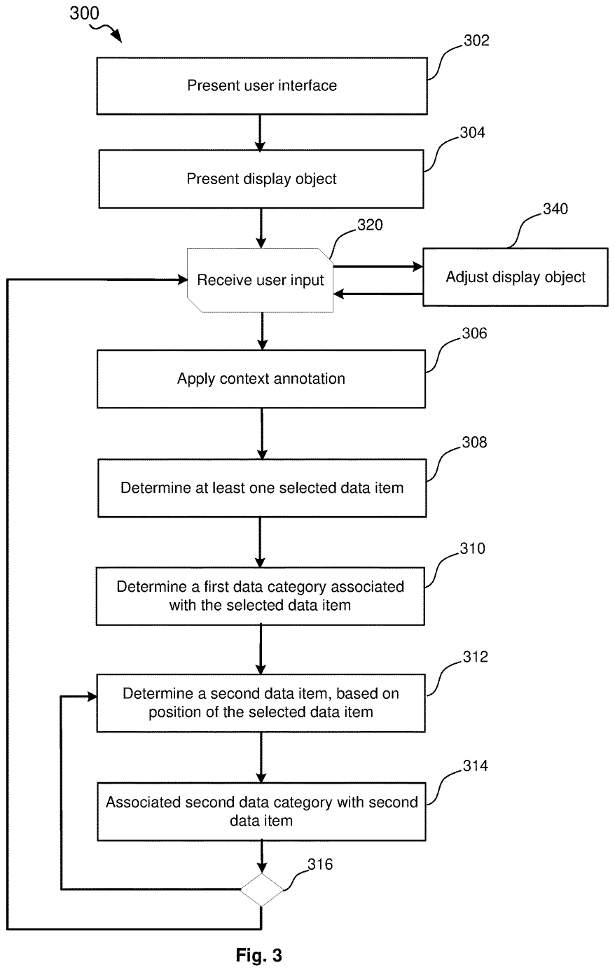

FIG. 1 is a block diagram of system 100 for determining a data category for a data item displayed in a display object on a graphical user interface of a client device 110, according to an embodiment. The system 100 of FIG. 1 provides means for implementing a graphical user interface (GUI), such as the GUI illustrated in FIG. 2, and means for implementing the method illustrated in process flow diagram FIG. 3.

As illustrated, the system 100 may comprise one or more client device(s) 110, external database 120, data presentation server 124, one or more bookkeeping system(s) 160 and/or one or more third party server(s) 170 in communication over a network.

Client device 110 may comprise a mobile or handheld computing device such as a smartphone or tablet, a laptop, or a PC, and may, in some embodiments, comprise multiple computing devices. The client device 110 may comprise one or more processor(s) 112, memory 114 and/or communications interface 118. The processor(s) 112 may comprise one or more microprocessors, central processing units (CPUs), application specific instruction set processors (ASIPs), application specific integrated circuits (ASICs) or other processors capable of reading and executing instruction code. The processor(s) 112 may be configured to receive stored instructions (i.e. program code) from memory 114, which when executed by the processor(s) 112 may cause the client device 110 to function according to the described embodiments. Client device 110 comprises one or more display screens 140, the or each of the one or more display screens 140 being configured to display the GUI, illustrated in FIG. 2, in implementing by computer a method, such as that illustrated in FIG. 3.

Functionality determining arrangement and content of the GUI is provided by the processor 112 hardware, and the memory 114 hardware, which may be cooperating with data presentation server 124 and/or bookkeeping system 160. The GUI may be an application 116 stored on the memory 114, or part of an application 116 stored on the memory 114. The application 116 may be a single page application served by the data presentation server 124 to the client device 110 over the network and displaying content from (for example, invoices or bills), or based on, data obtained from the bookkeeping system 160.

The memory 114 may comprise application 116 which comprises computer executable code, which when executed by the one or more processors 112, is configured to allow client device 110 to facilitate the intuitive viewing and navigation of data displayed on a screen 140 of the client device 110. The communications interface 118 facilitates communications with components of the communications interface 118 across the network, such as: database 120, data presentation server 124, bookkeeping system(s) 160 and/or third party server(s) 170. The communications interface 118 may comprise a combination of network interface hardware and network interface software suitable for establishing, maintaining and facilitating communication over a relevant communication channel.

The network may include, for example, at least a portion of one or more networks having one or more nodes that transmit, receive, forward, generate, buffer, store, route, switch, process, or a combination thereof, etc. one or more messages, packets, signals, some combination thereof, or so forth. The network may include, for example, one or more of: a wireless network, a wired network, an internet, an intranet, a public network, a packet-switched network, a circuit-switched network, an ad hoc network, an infrastructure network, a public-switched telephone network (PSTN), a cable network, a cellular network, a satellite network, a fibre-optic network, some combination thereof, or so forth.

The database 120 may form part of or be local to the system 100, or may be remote from and accessible to the system 100, for example, via the communications network. The database 120 may be configured to store data associated with the system 100. The database 120 may be a centralised database. The database 120 may be a mutable data structure. The database 120 may be a shared data structure. The database 120 may be a data structure supported by database systems such as one or more of PostgreSQL, MongoDB, and/or ElasticSearch. The database 120 may be configured to store a current state of information or current values associated with various attributes (e.g., “current knowledge”).

The data presentation server 124 may be configured to serve single page applications to the client device 110. Single page applications may comprise GUIs. The GUIs of single page applications provide a mechanism for a user of a client device to view, navigate, manipulate, and/or interact with, data stored by the bookkeeping system 160. The data stored by the bookkeeping system 160 may comprise, inter alia, representations of transaction data, such as digital or softcopy versions of account statements or transaction statements. The data stored by the bookkeeping system 160 may comprise representations of financial documents, such as bank account statements, invoices, bills, receipts, issued to or by the user (or a business or other legal entity on behalf of which the bookkeeping system 160 is providing an online bookkeeping service).

In some embodiments, the data presentation server 124 may comprise one or more processors 126 and memory 130 storing instructions (e.g. program code) which when executed by the processor(s) 126 causes the system 100 to function according to the described methods. The processor(s) 126 may comprise one or more microprocessors, central processing units (CPUs), application specific instruction set processors (ASIPs), application specific integrated circuits (ASICs) or other processors capable of reading and executing instruction code.

In some embodiments, the data presentation server 124 may operate in conjunction with or support one or more external devices, such as the client device 110, the database 120, the bookkeeping system(s) 160 and/or the third party server(s) 170, to manage the provision of an intuitive GUI for stored data.

The memory 130 may comprise one or more volatile or non-volatile memory types. For example, memory 130 may comprise one or more of random access memory (RAM), read-only memory (ROM), electrically erasable programmable read-only memory (EEPROM) or flash memory. Memory 130 is configured to store program code accessible by the processor(s) 126. The program code comprises executable program code modules. In other words, memory 130 is configured to store executable code modules configured to be executable by the processor(s) 126. The executable code modules, when executed by the processor(s) 126 cause the system 100 to perform the functionality according to the described embodiments, as described in more detail below. Memory 130 may comprise a single page applications (SPA) module 132, which stores and serves single page applications (SPAs) to user devices such as client devices. Memory 130 may comprise an authentication module 134, which may, for example, check credentials to enable users to login to the service.

### FIG. 2—User Interface

FIG. 2 is a block diagram of a graphical user interface (GUI) 200, as displayed by the application 116 on the display screen 140 of the client device 110, according to an embodiment. The GUI 200 comprises a graphical user interface; however, in other embodiments, the user interface may comprise a non-graphical user interface, or a combination of a graphical user interface and a non-graphical user interface. The non-graphical user interface may comprise tangible user-selectable interface items such as buttons or switches, a peripheral device such as a keyboard or a mouse, or other means of the user providing input to the application 116.

The GUI 200 comprises a section 202 in which to visually display a display object. In one embodiment, the display object comprises a visual representation of a financial document, or part thereof. In one embodiment, the display object comprises a visual representation of tabulated data items. In one embodiment, the display object comprises a scanned image of a bank account statement. In one embodiment, the display object comprises a visual representation of a bank account statement, a profit and loss statement, a balance sheet, financial information or data, transaction information or data, or a combination or portion thereof. In one embodiment, the display object comprises a visual representation of tabulated data items that do not comprise financial data.

The GUI 200 further comprises a plurality of user-selectable items 204. In one embodiment, the user selects a user-selectable item to apply a context annotation to the display object. For example, the user may select user-selectable item 210 to select a data category and to indicate that the user intends to apply a context annotation to one or more of the ‘withdrawal amount’ data items depicted on the display object. Alternatively, or additionally, the application 116 may be configured to select a data category and prompt the user, e.g. via the GUI 200, to apply a context annotation in accordance with the data category selected by the application 116. In embodiments, the application 116 is configured to automatically determine a next data category for context annotation, based on the data category that was previously annotated. For example, the application may prompt the user to apply a context annotation for the ‘posted date’ data category, then, in response to the user applying a context annotation, the application 116 may prompt the user to apply a context annotation for the ‘account balance’ data category. In embodiments, the application 116 is configured to determine a user-selected data category in response to receiving input from a peripheral device, such as a keyboard.

In embodiments, the application 116 is configured to automatically determine a next data category for context annotation, based on a data category that was previously annotated and the data categorisation and position of data items that have been categorised by the application. For example, the application may prompt the user to apply a context annotation for the ‘account balance amount’ data category, then, in response to the user applying a context annotation, and in response to the categorised data items being not located in the rightmost column of the data items, the application 116 may prompt the user to apply a context annotation for the ‘deposit amount’ data category in order to differentiate between two columns of data items which may be either deposit data items or withdrawal data items.

The application 116 of the client device 110 is responsible for detecting user interactions with the graphical user interface (GUI) 200, and feeding data representing the detected user interactions to the GUI so that the GUI can respond according to the GUI configuration.

In embodiments, the display object is displayed via the GUI 200 as a manifestation of processing performed by the application 116. In embodiments, the GUI 200 provides means for the user to interact with the display object. Elements of the display object may be selectable, annotatable, scrollable, and/or scalable, or otherwise interacted with by the user, via use of the GUI and user controls associated with the client device. User controls may comprise peripheral devices such as a mouse or a keyboard communicatively coupled to the client device 110, or touch screen functionality of the display screen 140.

### FIG. 3—Process Flow Diagram

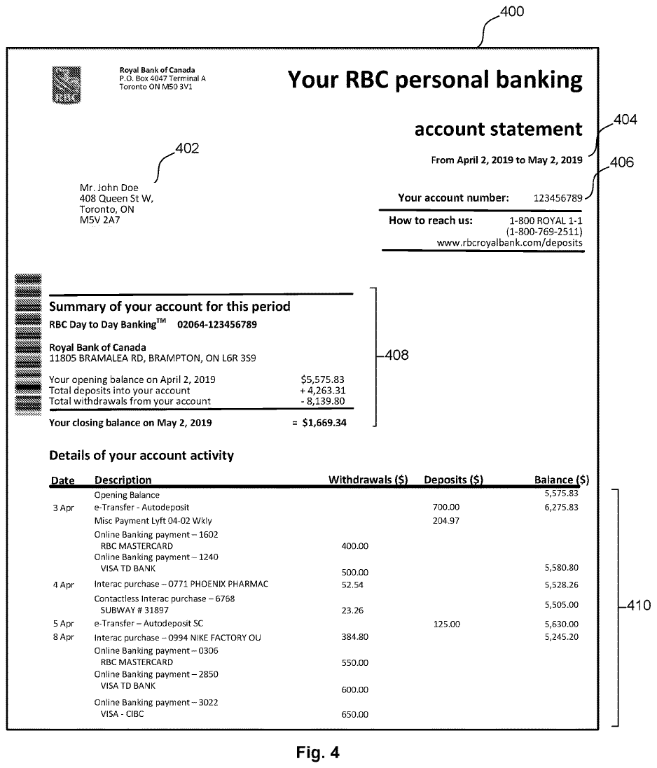

FIG. 3 is a process flow diagram of a process 300, performed by the application 116, to categorise data items based on user-provided context annotations, according to an embodiment. Embodiments of the process of FIG. 3 are described below with reference to FIGS. 4 to 12.

In step 302, the application 116 presents, on the client device 110, a user interface. In step 304, the application presents, on the GUI 200, a display object. In one embodiment, the display object comprises a scanned image of a hardcopy of a financial statement, such as a bank account statement. In one embodiment, the display object comprises a digital representation of financial information. The financial statement may comprise data items indicating posted dates, transaction dates, transaction descriptions, withdrawal amounts, deposit amounts and account balances. In one embodiment, the data items depicted on the display object are arranged in a tabular form.

In step 306, in response to receiving a user input 320, via the GUI 200, the application 116 applies a context annotation to the display object 400.

In step 308, the application 116 determines, based on the context annotation, at least one selected data item of the plurality of data items. In step 310, the application determines a first data category associated with the selected data item.

In step 312, the application 116 determines, based on a position of the selected data item in the tabular form, a second data item of the plurality of data items, and in step 314, the application associates a second data category to the second data item, based on the first data category.

In some embodiments, following step 314, the application 116 determines, in decision 316, whether to repeat another iteration of steps 312 and 314. Decision 316 may take into account whether there are further data items which may be categorised based on the categories of data items for which the application has already determined a data category. At decision 316, the application 116 may return to step 312, in which the application determines, based on a position of the selected data item in the tabular form, a third data item of the plurality of data items, and in step 314, the application may associate a third data category to the third data item, based on one or more of the first data category, the second data category, or both the first and the second data categories. Accordingly, the application may perform steps 312 and 314 iteratively to determine data categories for a plurality of data items, based on the position of a selected data item and the data category associated with that selected data item.

Process 300 may be applied iteratively, such that, in response to receiving a second user input 320, the application 116 may apply a second context annotation to the display object 400.

### FIG. 4—Account Statement Image

FIG. 4 illustrates display object 400 as displayed on the GUI 200 of the client device 110, according to an embodiment. Display object 400 comprises a visual representation of an account statement for an example bank account held by the Royal Bank of Canada. In embodiments, the display object may comprise a scanned or photographed copy of a page of a paper hardcopy of an account statement. The display object may comprise a machine-encoded information, non-machine-encoded information, or a combination thereof. In some embodiments, the display object does not comprise machine-encoded text. Accordingly, optical character recognition (OCR) module (also referred to as a character recognition module), or similar, may apply a character recognition algorithm to the display object to determine machine-readable characters represented in the display object. The machine-readable characters may comprise alpha-numerical characters.

Display object 400 visually represents an address and name 402 of the account holder. Furthermore, display object 400 visually represents a date period 404 for which the account statement applies. Display object 400 also visually represents an account number 406 and summary information 408.

Display object 400 also visually represents a plurality of data items 410 which are arranged in a tabular form, i.e. the data items are arranged in a plurality of columns and rows. In particular, the rows of the tabulated data items are associated with individual financial transactions that have occurred on the bank account associated with account number 406. Furthermore, the columns of the tabulated data items, on display object 400, are associated with various attributes of the financial transactions; namely, the posted date of the transaction, a description of the transaction, the amount of funds withdrawn (if any), the amount of funds deposited (if any) and the balance of the account in response to the occurrence of the financial transaction.

In embodiments, information represented by display objects may comprise additional attributes, fewer attributes or a different set of attributes. For example, a display object may comprise an invoice and include only data items belonging to an amount category and a description category.

In one embodiment, in accordance with steps 302 and 304 of process 300, the GUI 201 displays financial information as display object 400 on the display screen 140 of the client device 110.

### Determining Tabular Form

In one embodiment, the application 116 is configured to determine a tabular form of the data items 410 of the display object 400. In one embodiment, the application 116 is configured to determine a tabular form of the data items 410 based on a context annotation applied by the user via the GUI 200. Alternatively, the application 116 may be configured to determine a tabular form of the data items 410 without consideration of a context annotation applied by the user.

In one embodiment, the application is configured to determine one or more individual rows of associated data items. In one embodiment, the application determines the delineation of rows of the tabular form in light of the orientation of the text characters in the display object 400.

In one embodiment, the application 116 is configured to determine one or more individual columns of associated data items. In one embodiment, the application identifies individual data items based on the white space between the data items. In one embodiment, the application identifies individual data items based on a vertical alignment of a subset of the data items and/or a horizontal alignment of a subset of the data items. In one embodiment, the application 116 applies machine learning or artificial intelligence techniques to determine the tabular form of the data items.

In one embodiment, the application 116 is configured to annotate the display object 400 with a visual indication of the tabular form that has been determined by the application. The visual indication of the tabular form may be referred to as a tabular form indication. The tabular form indication may comprise lines, shading, spatially associated text (e.g. column headings) or any combination thereof.

In one embodiment, the user may indicate, via use of the GUI 200, that the tabular form indicated by the application is not correct or should be adjusted. The user may indicate, via user input 320, adjustments to the tabular form indicated by the application. In response to user input 320, the application may adjust 340 the determined tabular form of the data items 410. The application may visually indicate the adjusted tabular form of the data items 410 via annotating the display object with an adjusted tabular form indication.

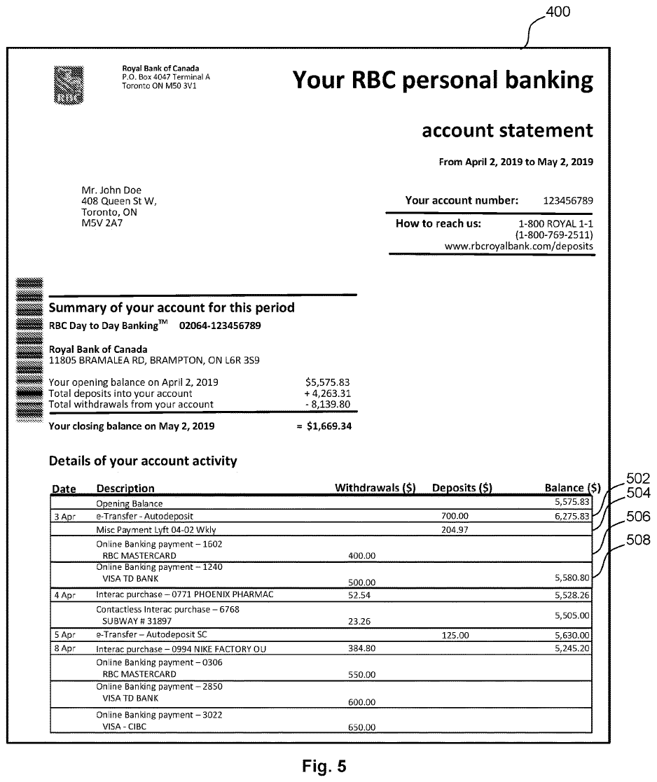

### FIG. 5—Example Determined Tabular Form

FIG. 5 illustrates the display object 400, annotated by the application 116 with lines representing the tabular form of the data items 410, as determined by the application 116, according to an embodiment.

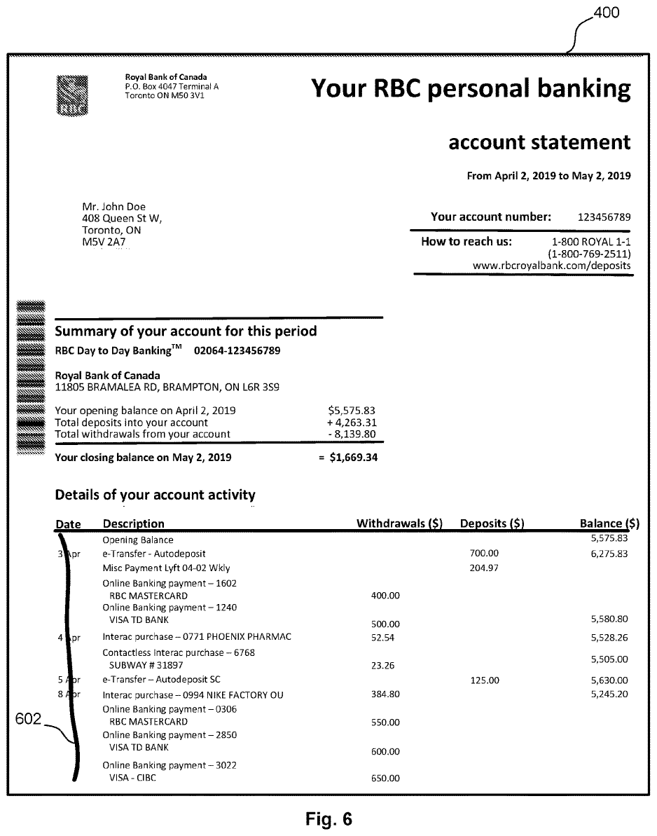

The annotations illustrated in FIG. 6 comprise elongated rectangles, wherein each rectangle encompasses a plurality of correlated data items in a row of the tabular form. For example, rectangle 502 encompasses the correlated row of data items comprising ‘3 April’, ‘e-Transfer—Autodeposit’, ‘700.00’ and ‘6,275.83’; rectangle 504 encompasses the correlated row of data items comprising ‘Misc Payment Lyft 04-02 Wkly’ and ‘204.97’; rectangle 506 encompasses the correlated row of data items comprising ‘Online Banking payment—1602 RBC MASTERCARD’, and ‘400.00’; and rectangle 508 encompasses the correlated row of data items comprising ‘Online Banking payment—1240 VISA TD BANK’, ‘500.00’ and ‘5,580.80’.

In embodiments, annotations indicating the tabular form of the data items may comprise colour differentiations, tonal differentiations, shading, text overlays, text or numerical annotations or other visual indicators which indicate the arrangement of data items into rows and columns.

### Context Annotations

The GUI 201 provides functionality for the user to visually annotate the display object 400. In one embodiment, the user can visually annotate the display object 400 via operating a peripheral device, such as a mouse, to indicate a position or series of positions on the display object. In one embodiment, the display screen 140 comprises a touch screen and the GUI 201 is configured to apply a visual context annotation the display object 400 in response to the user touching the representation of the display object 400 on the display screen.

In one embodiment, the visual context annotation comprises one or more regular (i.e. straight) or irregular (e.g. free-hand) lines. In one embodiment, the line may comprise a continuous, or may comprise a non-continuous line, such as a dashed or dotted line. In one embodiment, the context annotation comprises one or more irregular (e.g. free-hand) lines which encompass, or substantially encompass a portion of the display object. In one embodiment, the context annotation comprises one or more two-dimensional shapes such as a triangle, rectangle, square, circle, oval, and/or a polygon. In one embodiment, the context annotation comprises a colour and/or a pattern. For example, the context annotation may comprise a red line, or a rectangle with a green perimeter, or a square with yellow cross-hatching. In one embodiment, the context annotation comprises a visual mark spatially associated with one or more of the data items. In one embodiment, the context annotation comprises a dot, line or other mark, spatially associated with one or more data items.

In one embodiment, the GUI 201 is configured to enable a user to annotate the display object 400 with a plurality of context annotations. Each of the plurality of context annotations may be visually distinct from the other context annotations in terms of colour, shape, visual effect, pattern, associated alphanumeric annotations, or any combination thereof.

In one embodiment, the user applies a context annotation to indicate, to the application 116, context information associated with one or more data items of the display object.

In one embodiment, the GUI 201 is configured to enable the user to select a data category via the GUI. For example, the GUI 201 may comprise a plurality of user-selectable items 204, such as buttons, icons or menu entries. Each of the items may represent a different data category.

In one embodiment, the GUI 201 comprises a plurality of user-selectable buttons which each correspond to a different data category with which the plurality of data items may be categorised. In one embodiment, the data categories comprise categories associated with a bank account statement, such as posted date, transaction date, transaction description, withdrawal amount, deposit amount and account balance.

In one embodiment, the plurality of data items comprise training data for training a machine learning algorithm. In one embodiment, the data categories comprise labels with which to label the data items.

### FIG. 6—Annotate Posted Dates

FIG. 6 illustrates display object 400 which has been annotated by the user, via interaction with the GUI 200, according to an embodiment. In the example illustrated in FIG. 6, the user has selected the ‘posted date’ category via activation of the interface item 206. The user has then used a peripheral mouse associated with the client device 110 to visually annotate the display object 400 with the substantially vertical line 602.

The line 602 spatially intersects four data items within the plurality of data items 410, which are arranged in a tabular form. With this action, the user has indicated, to the application 116, that the data items (‘3 April’, ‘4 April’, ‘5 April’ and ‘8 April’) each represent posted dates. Accordingly, by visually annotating the display object 400 with line 602, the user has provided the application 116 with contextual information. Line 602, which indicates the ‘posted date’ data items, may be coloured in a colour that signifies the entries are ‘posted date’ data items.

In one embodiment, in accordance with step 306 of process 300, in response to receiving user input via the user interface, the application 116 applies a context annotation to the display object. In one embodiment, in accordance with step 308 of process 300, the application 116 determines, based on the context annotation, at least one selected data item, being data items ‘3 April’, ‘4 April’, ‘5 April’ and ‘8 April’, of the plurality of data items. In one embodiment, the application 116 determines the at least one selected data item based on a position of the context annotation on the display object relative to the position of selected data item on the display object. In one embodiment, the application 116 determines the at least one selected data item based on a distance between the context annotation and the selected data item. In one embodiment, the context annotation spatially intersects, or at least partially spatially intersects, the selected data item. In one embodiment, the context annotation encompasses, or at least partially encompasses, the selected data item.

Furthermore, in accordance with step 310 of process 300, the application 116 determines a first data category, being the ‘posted date’ category, associated with data items ‘3 April’, ‘4 April’, ‘5 April’ and ‘8 April’.

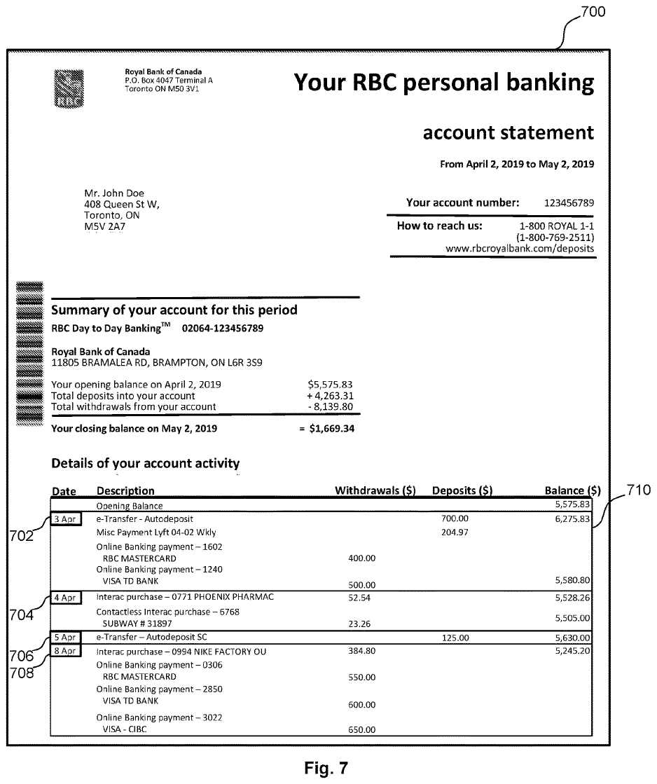

### FIG. 7—Consolidated Tabular Form

In one embodiment, if the application 116 has determined a tabular form of the data items 410, the application 116 is configured to adjust the determined tabular form of the data items 410 based on one or more context annotations provided by the user via the GUI 200. For example, the application may determine that one or more rows of the determined tabular form may be grouped together, or consolidated, because the data items in these one or more rows are associated.

In one embodiment, if the application 116 has not yet determined a tabular form of the data items 410, the application 116 is configured to determine a tabular form of the data items 410 based on one or more context annotations provided by the user via the GUI 200.

FIG. 7 illustrates the display object 400, annotated by the application 116 with lines representing a consolidated tabular form of the data items 410, as determined by the application in light of the context annotation, according to an embodiment.

In one embodiment, the user may indicate, via use of the GUI 201 that the consolidated tabular form, determined by the application 116, is not correct or should be adjusted.

### Categorisation Indication

In one embodiment, the application 116 is configured to visually indicate the category of data items that have been context annotated by the user.

Referring again to FIG. 7, the application 116 has visually indicated that data item ‘3 April’ has been categorised by the application as a ‘posted date’ data item by applying a categorisation indication. In the example illustrated in FIG. 7, the categorisation indication comprises a rectangle 704 which encompasses the data item ‘3 April’.

Similarly, the application 116 annotates the display object 400 with additional categorisation indications 702 to indicate the other ‘posted date’ data items, by encompassing them in rectangles 704, 706 and 708, respectively. In one embodiment, the categorisation indications 702, rectangles 704, 706 and 708, are coloured in the same colour as line 602.

The application 116 may perform a validation process in which the application validates whether the context annotation is consistent with the format or value of the annotated data item(s). For example, the application may consider the format of a data item that the user has applied a ‘posted date’ context annotation to, to determine whether the data item represents a date. In performing the validation process, the application may consider: the alpha-numeric content of the data item; a mathematical relationship between the numerical value represented by the data item and the number value represented by one or more other data items; the position of the data item in the display object; the relative position of the data item compared to the position of a data item that has been categorised in response to a context annotation; or any combination of two or more of these aspects.

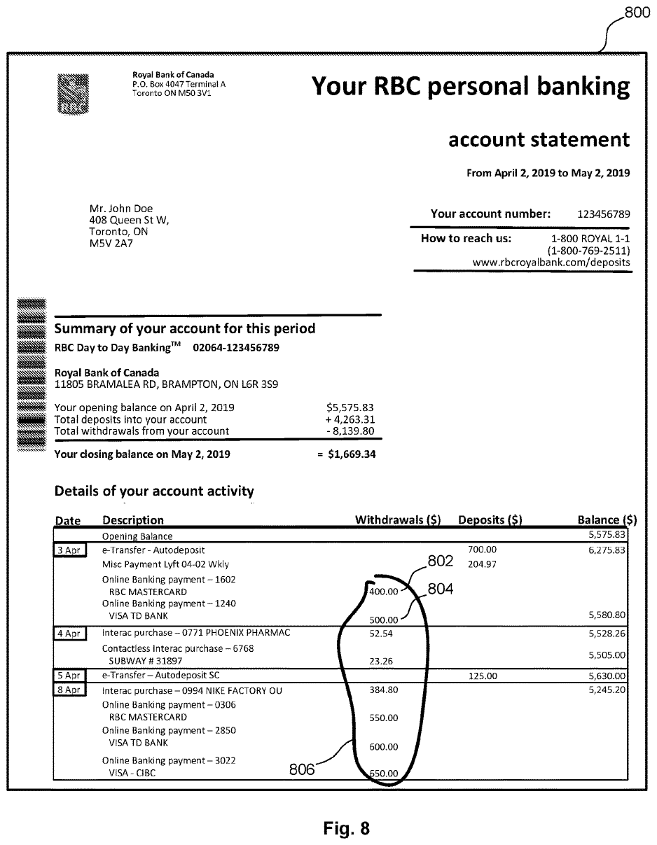

### FIG. 8—Annotating Withdrawal Data Items

FIG. 8 illustrates display object 400 which has been further annotated by the application 116 in response to receiving user input from the user (via the user interface), according to an embodiment.

In the example illustrated in FIG. 8, the user has selected the withdrawal amount category via activation of the interface item 210. The user has then used a peripheral mouse associated with the client device 110 to visually annotate the display object 400 with the line 806.

The line 806 substantially encompasses eight data items within the plurality of data items 410, which are arranged in a tabulated form. With this action, the user has indicated, to the application 116, that the data items (400.00, 500.00, 52.54, 23.26, 384.80, 550.00, 600.00, 650.00) represent withdrawal amounts. Accordingly, by visually annotating the display object 400 with line 806, the user has provided the application 116 with contextual information for the data items which are encompassed (or substantially encompassed) by line 806. Line 806, which indicates the withdrawal amount data items, may be coloured in a colour that signifies the entries are withdrawal amount data items.

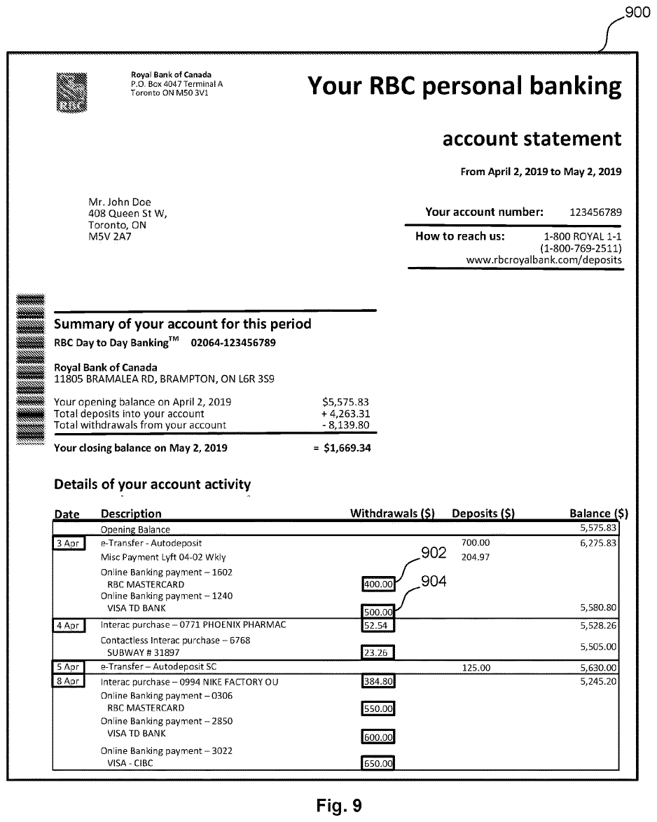

### FIG. 9—Indicating Withdrawal Data Items

FIG. 9 illustrates display object 400 which has been further annotated by the application 116 to produce display object 700, according to an embodiment. The application has annotated display object 400 to visually indicated that data item ‘400.00’ is a withdrawal amount data item by applying a categorisation indication. In the example illustrated in FIG. 9, the categorisation indication comprises a rectangle 902 which encompasses the data item. Similarly, the application has annotated display object 400 to apply categorisation indications to the other withdrawal amount data items by encompassing them in rectangles, such as rectangle 904. In one embodiment, the rectangles indicating the withdrawal amount data items are coloured in the same colour as line 806.

### Categorisation Indications

In one embodiment, a categorisation indication comprises a rectangle which encompasses a data item in the display object. In one embodiment, the categorisation indication comprises: highlighting the data item; annotating the display object to change the color of the text of the data item; applying a background effect to the data item; underlining the data item; labelling the data item; applying any effect which visually distinguishes the categorised data item from uncategorised data items, or data items of a different category; or any combination of these aspects.

In one embodiment, the application 116 applies a first categorisation indication for a first data category, and a second categorisation indication for a second data category. The first data categorisation is visually distinct from the second data categorisation in terms of colour, shape, visual effect, pattern, associated alphanumeric annotations, or any combination thereof.

In some situations, data items which are displayed in a single column may not all be associated with the same data categorisation. For example, in one display object, the deposit amounts and the withdrawal amounts may be spatially located in the same column. Accordingly, in one embodiment, the application 116, in response to receiving context annotations associated with only a subset of the data items in a column, is configured to determine and visually indicate a data categorisation for the data items in that subset. The application 116 may categorise data items that are spatially located in the same column, but not indicated by the user by the context annotation, with a different data categorisation, or may not categorise the data items until the application receives further input from the user.

### Inferring Data Item Categorisation

Advantageously, by determining the data categories of a subset of the data items 410, via the context annotations provided by the user, the application can determine the data categories of other data items displayed in the display object.

In one embodiment, based on the categorisation of the ‘posted date’ data items (categorisation indications 702), the application determines a data category associated with another data item.

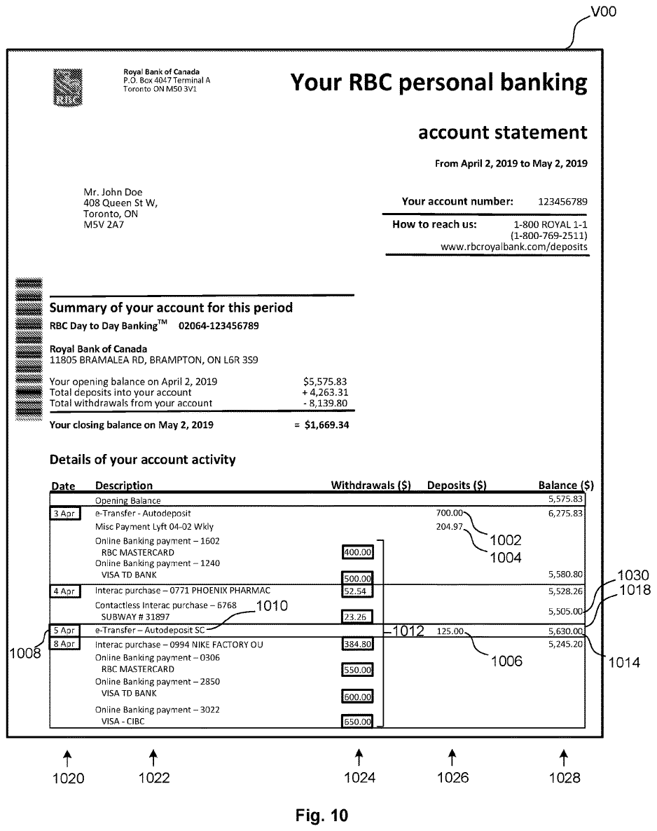

### FIG. 10—Inferring Data Item Categorisations Example

FIG. 10 illustrates a display object in which the application determines data item categorisations based on user-indicated data categorisations, according to an embodiment.

In the example illustrated in FIG. 10, the application has determined a tabular form for the data items 410. Accordingly, the application has associated data items ‘5 April’, ‘e-Transfer-Autodeposit SC’, ‘125.00’ and ‘5,630.00’ as being in the same row 1018. The application also determines that the data items 410 are arranged in 5 columns (1020, 1022, 1024, 1026 and 1028), with row 1018 not including a data item in column 1024.

In response to the context annotation, the application displays a categorisation indication 1008 associated with the data item ‘5 April’ to indicate that this data item is a ‘posted date’ data item. Furthermore, in response to the context annotation, the application displays a categorisation indication for each of the withdrawal amount data items (collectively labelled 1012).

Based on the categorisation of data item ‘5 April’ as a ‘posted date’ data item, and the categorisation of the data items in column 1024 as withdrawal amount data items, the application may be configured to infer that the data items in columns 1022, 1026 and 1028 relate to one of the categories: transaction description, deposit amount, or account balance.

The application may infer a category for a data item based on: the alpha-numeric content of the data item; a mathematical relationship between the numerical value represented by the data item and the number value represented by one or more other data items; the position of the data item in the display object; the relative position of the data item compared to the position of a data item that has been categorised in response to a context annotation; or any combination of two or more of these aspects.

In one embodiment, based on data item 1010 comprising letter characters, and data items 1006 and 1014 comprising numerals, the application infers that data item 1010 comprises a transaction description.

In one embodiment, based on data item 1014 being located on the right hand side of the display object, the application infers that the data item 1014 comprises an account balance.

In one embodiment, the display object comprises at least three columns of numerical values, a leftmost, a middle and a rightmost column of numerical values. The application 116 may have determine, for example in response to receiving a context annotation, that the numerical values in the leftmost column comprise withdrawal amount data items. The application may infer that the numerical values located in the rightmost column comprise account balance data items, and the numerical values located in the middle column comprise deposit amount data items.

In one embodiment, based on column 1024 comprising withdrawal amount data items, the application infers that column 1026, and data item 1006, comprise deposit amount data items.

In one embodiment, based on the mathematical relationship between the numerical values represented by data items 1006, 1014 and 1030 (i.e. 5,5050.00+125.00=5,630.00), the application infers that column 1026 comprises deposit amount data items and column 1028 comprises account balance data items.

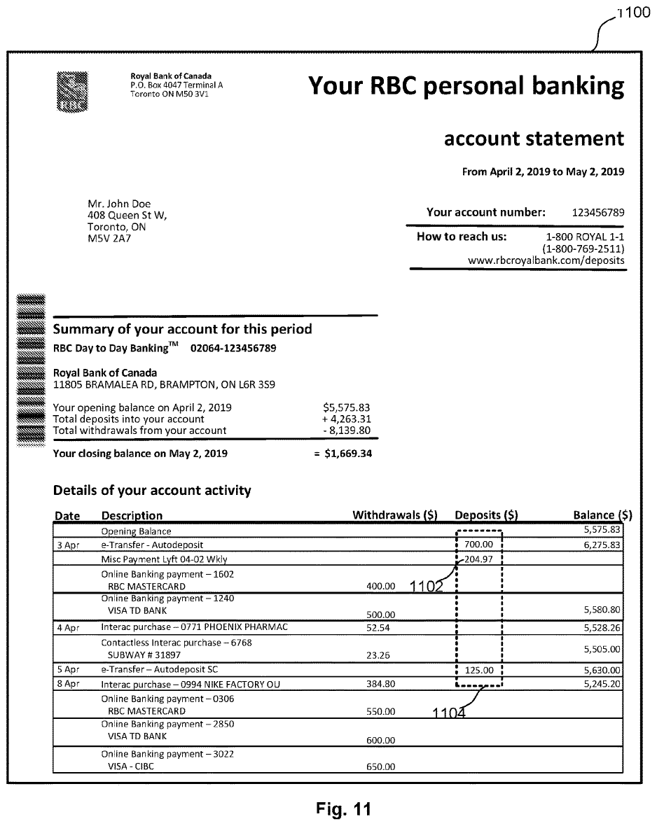

### FIG. 11—Annotating Deposit Amount Data Items

FIG. 11 illustrates a display object 1100, which has been annotated by the application to indicate the tabular form of the data items, as determined by the application, according to an embodiment. In the example of FIG. 11, the application has not yet received input from the user to indicate the context of the data items.

In the example illustrated in FIG. 11, the user has selected the deposit amount category via activation of the interface item 212. The user has then used a peripheral mouse associated with the client device 110 to visually annotate the display object 1100 with the dashed rectangle 1102.

The dashed rectangle 1102 encompasses three data items within the plurality of data items 410, which are arranged in a tabulated form. With this action, the user has indicated, to the application 116, that the data items (700.00, 204.97, 125.00) represent deposit amounts. Accordingly, by visually annotating the display object 1100 with dashed rectangle 1102, the user has provided the application 116 with contextual information for the data items which are encompassed (or substantially encompassed) by dashed rectangle 1102. Dashed rectangle 1102, which indicates the deposit amount data items, may be coloured in a colour that signifies the entries are deposit amount data items.

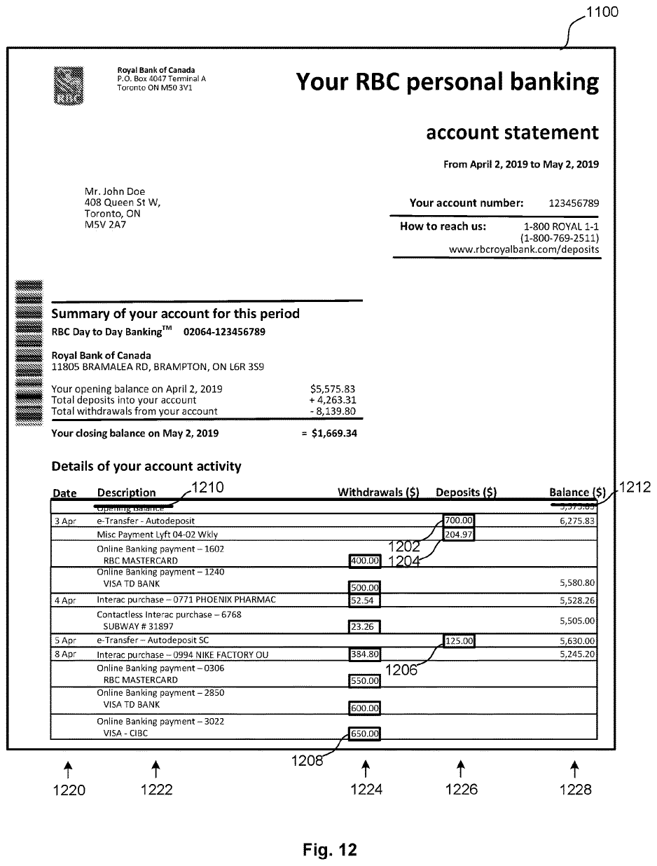

### FIG. 12—Indicating Deposit Data Items

FIG. 12 illustrates display object 1100 which has been annotated by the application 116 in response to receiving context indication from the user, according to an embodiment. In response to receiving user input, the application has annotated display object 1100 to visually indicated that data item ‘700.00’ is a deposit amount data item by encompassing the data item in a rectangle 1202. Similarly, the application has annotated display object 1100 to visually indicate the other deposit amount data items by encompassing them in rectangles, such as rectangles 1206 and 1208. In one embodiment, the rectangles indicating the deposit amount data items are coloured in the same colour as dashed rectangle 1102.

The application 116, based on the context annotation 1104 determines data item. The application categorises data item as a deposit amount data item. The application determines that data item is positioned in column 1226. Based on the position of data item in column 1226, the application selects a second data item (being the data items in column 1224), and infers that the second data item belongs to the withdrawal amount category. Accordingly, the application associates a second data category, being the withdrawal amount data category, to the data items in column 1224. The application 116 visually indicates the inferred categorisation of the data items in column 1224 as withdrawal amounts by encompassing them in rectangles, such as rectangle 1208.

### Differentiating by Colour

Context annotations applied by the user, via the user interface, may utilise colour to differentiate between context annotations associated with different data entry categories. For example, in the example scenario in which the display object is a bank account statement, such as display object 400, the context annotations applied by the user to indicate the ‘posted date’ data items may be indicated in red. Similarly, the context annotations applied by the application to indicate that the data items are ‘posted date’ data items may also be indicated in red. The context annotations applied by the user to indicate the withdrawal amount data items may be indicated in blue. Similarly, the context annotations applied by the application to indicate that the data items are withdrawal amount data items may also be indicated in blue.

### Validating Inferred Categorisations

In one embodiment, the application 116 provides for the user to trouble shoot, validate or remove errors from an inferred categorisation of the data items in a display object. In one embodiment, the application annotates the display object with one or more categorisation indications which represent inferred categorisations of the data items in the display object. The inferred categorisations may be determined by the application 116, or may be determined by another application. The application 116 provides for the user, via the GUI 200, to provide user input, represented by context annotations, that contradict, adjust or confirm the inferred categorisations represented by the categorisation indications. In response to receiving user input 320, via the user interface, the application 116 adjusts 340 the inferred categorisations based on the context annotations.

### Redaction

In one embodiment, the application 116 is configured to enable a user to apply a context annotation to categorise a data item as redacted, deletable or not relevant. In one embodiment, the GUI 200 comprises a user-selectable item 204 indicating a redact categorisation, which may be utilised by the user to redact data items from the plurality of data items represented in the display object. In one embodiment, the GUI 200 enables the user to associate a text comment to the redacted data item(s).

Referring again to FIG. 12, the user has applied context annotations 1210 and 1212 to redact data items ‘Opening Balance’ and ‘5,575.83’, respectively.

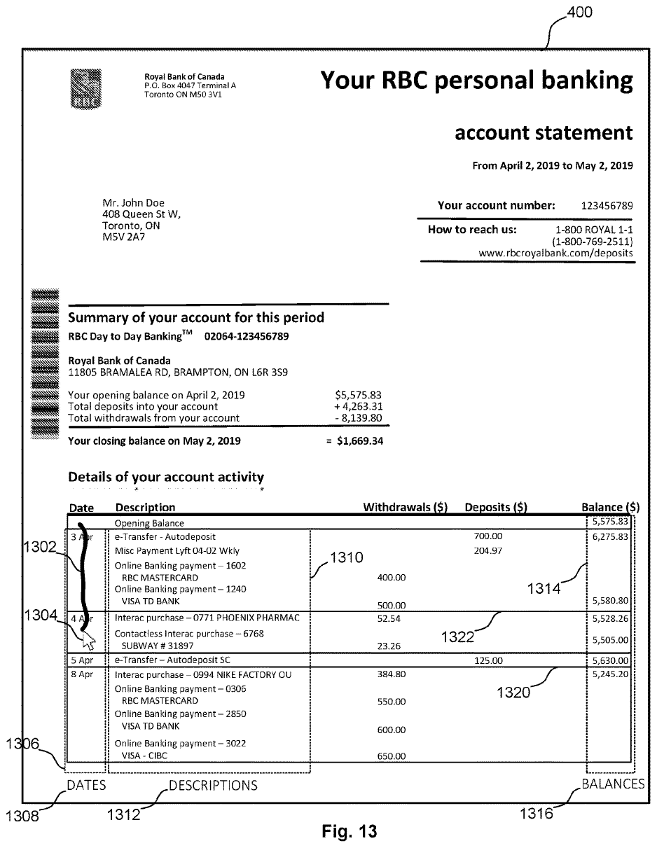

### FIG. 13—Categorisation Predicting

The application 116 may be configured to predict the categorisation of data items as the user applies the context annotation, and to display predicted data categorisations as the user applies a context annotation.

FIG. 13 illustrates display object 400 at a point in time at which the user is applying a context annotation, according to an embodiment. The user has selected the ‘posted date’ category via activation of the interface item 206. In an alternative instance or embodiment, the user may be prompted by the application to apply a context annotate for data items belonging to the ‘posted date’ category.

As illustrated by mouse pointer icon 1304, the user is in the process using a peripheral mouse associated with the client device 110 to visually annotate the display object 400 with the substantially vertical line 1302.

At the point in time illustrated in FIG. 13, the line 1302 intersects two data items within the plurality of data items 410, which are arranged in a tabular form. With this action, the user has indicated, to the application 116, that the data items ‘3 April’ and ‘4 April’ each represent posted dates.

Based on the relative position of the data items ‘3 April’ and ‘4 April’, being aligned in a column, the application 116 can predict that the remaining data items (‘5 April’ and ‘8 April’) also each represent posted dates. Accordingly, the application 116 applies a predicted categorisation indication to indicate to the user the data categorisation predicted by the application. In the example illustrated in FIG. 13, the predicted categorisation indication comprises dotted rectangle 1306 and ‘DATES’ label 1308.

In one embodiment, in response to the user discontinuing application of the context annotation, for example by releasing the mouse button, the application 116 determines that the predicted categorisation is acceptable to the user. In one embodiment, the user can indicate, via user input 320 with the GUI 200, that the predicted categorisation is acceptable to the user. In one embodiment, the user can indicate, via user input 320 with the GUI 200, corrections or adjustments to the predicted categorisation. The application may be configured to adjust 340 the predicted categorisation indication on the display object in response to receiving user input 320.

In one embodiment, in response to the application 116 determining that the predicted categorisation is acceptable, the application displays a categorisation indication for the categorised data items, for example, categorisation indications 702.

In one embodiment, in addition to predicting a categorisation for the data items indicated by the context annotation, the application 116 also predicts the categorisation of other data items represented in display object 400.

The application may predict a categorisation for a data item based on: the alpha-numeric content of the data item; a mathematical relationship between the numerical value represented by the data item and the number value represented by one or more other data items; the position of the data item in the display object; the relative position of the data item compared to the position of a data item that has been categorised in response to a context annotation; or any combination of two or more of these aspects.

Dotted rectangle 1310 and label 1312 comprise predicted categorisation indications to indicate the data items that the application 116 has predicted to belong to a ‘transaction description’ data category. Dotted rectangle 1314 and label 1316 comprise predicted categorisation indications to indicate the data items that the application 116 has predicted to belong to the ‘account balance’ data category.

In accordance with the example illustrated in FIG. 13, while the user is applying the context annotation, the application predicts the consolidated tabular form of the data items 410. For example, lines 1320 and 1322 are annotations applied by the application 116 to represent the predicted consolidated tabular form of the data items 410, as determined by the application in light of the ‘in-progress’ context annotation, according to an embodiment.

### Extracting Data

It is desirable to extract, from an input document, the information provided in the input document. The extracted information may then be stored and processed as needed. In some situations, the input document comprises machine-encoded text. Accordingly, the information provided within the input document may be readily extracted in accordance with the file format of the input document. In some situations, the display object may not comprise machine-encoded text. For example, the display object may comprise an image file, such as a photograph or a scan of a document.

In embodiments, the application 116 is configured to apply an extraction process to extract data items depicted in a display object. The extraction process comprises identifying an alpha-numeric data item in the display object, determining the alpha-numeric value of the data item, and storing that alpha-numeric value of the data item in memory accessible to the application.

The extraction process may comprise an automatic extraction process, performed without input from a user. The automatic extraction process may comprise applying an optical character recognition (OCR) algorithm to extract one or more data values from the display object.

The extraction process may comprise a manual extraction process, in which a user uses the GUI 200 to indicate the position of a data item in the display object, and the alpha-numeric value of the data item. The application may then store the data item in memory.

The extraction process may comprise one or more machine learning (ML) models to locate and extract data items (including alphanumeric data and symbols) from the document. The ML model may be an AI model that incorporates deep learning-based computation structures, including artificial neural networks (ANNs).

In one embodiment, the extraction process is performed by a text extraction service. The text extraction service may comprise an optical character recognition (OCR) service. In one embodiment, the text extraction service comprises Amazon Textract. In one embodiment, the text extraction service comprises a combination of third-party software services or libraries, and custom data extraction services or libraries.

The extraction process may comprise storing, in association with the data item, positional information indicating the location of the data item within the display object.

The extraction process may be configured to extract a set of associated data items. For example, the extraction process may be configured to extract data items that it determines are all associated with a single financial transaction. In response to the extraction process determining the presence of a data item, but being unable to determine whether the data item is associated with a financial transaction, or which other data items are associated with the determined data item, the extraction process may not extract the data item.

In some situations, the extraction process may not extract all the data items from a display object. The extraction process may not extract all the data due to one or more of: inability of the extraction process to recognise the alpha-numeric value of a data item; obscuring of the data item; inability of the extraction process to determine a categorisation associated with the data item; inability of the extraction process to determine a set of data items associated with the data item; another factor preventing the extraction process from extracting the data item; or any combination thereof.

### Categorising Data

The data items provided within the display object may be categorised into a plurality of data categories. This categorisation may facilitate the processing of the data items by the accounting and booking keeping applications (116 and 160). The plurality of categories may be defined within a set of categories associated with the display object. The application may be configured to select the set of categories based on a type of the display object. For example, in response to determining that the display object comprises a transaction statement for a bank account, the application may determine a set of categories comprising: posted date category; transaction description category; deposit amount category; and withdrawal amount category.

### Indicating Extracted Data Items

It may be desirable to visually distinguish for a user the data items that the application 116 has extracted from the display object, and the data items that the application has not extracted from the display object.

The application may be configured to indicate the extracted data items by annotating the visual appearance of the display object to highlight the extracted data items. Conversely, the application may be configured to indicate the extracted data items by annotating the visual appearance of the display object to highlight the data items that have not been extracted by the application.

The application applies a visual indicator to visually indicate the data item to a user. Applying the visual indicator comprises changing the appearance of the data item as it appears to the user. In some embodiments, the visual indicator comprises one or more of: a shape encompassing, or partially encompassing the data item; an overlay over the extracted data item; a change in font of the data item, a change in colour or size of the data item; a change in background colour behind the data item (e.g., highlighting the data item); a visual indicator displayed in proximity to the data item; a visual indicator displayed in response to the user selecting the data item (e.g., by a mouse-click or a mouse-over of the data item in the display object).

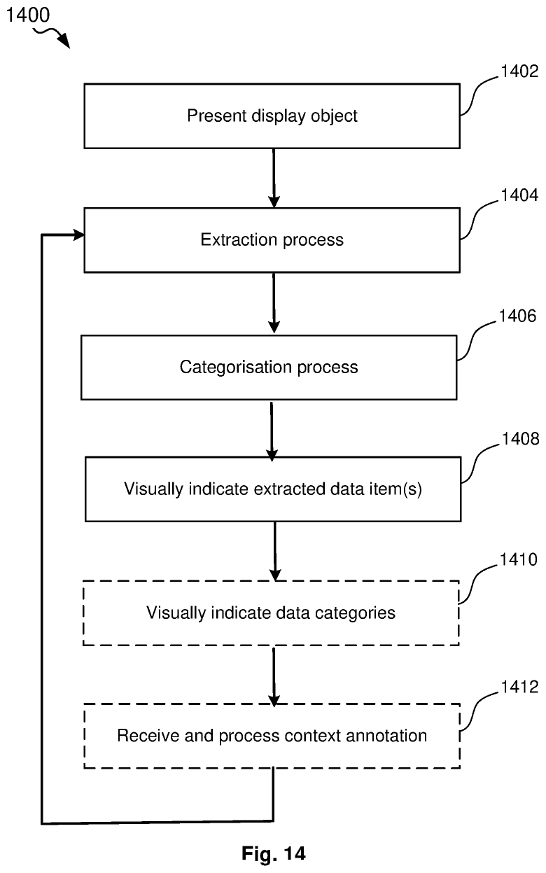

### FIG. 14—Method

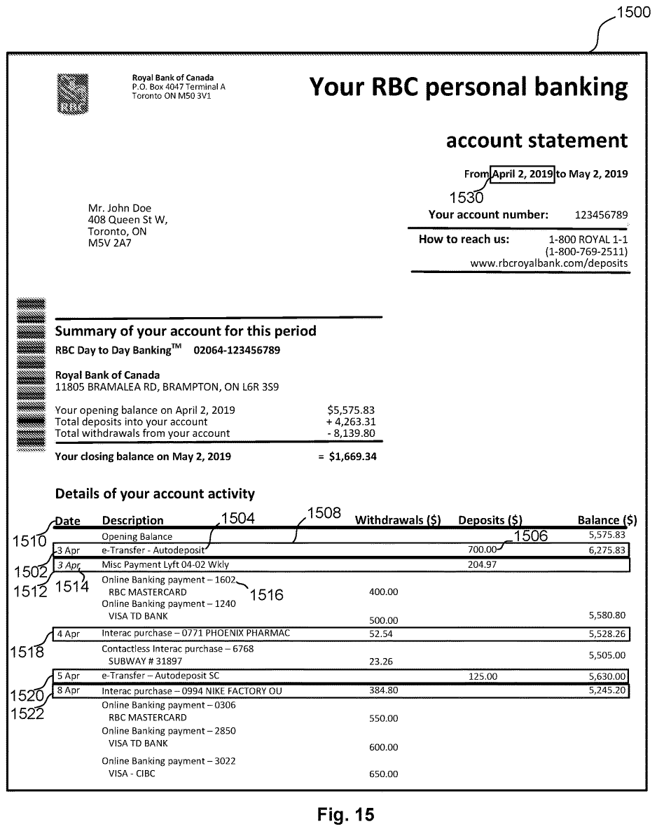

FIG. 14 is a process flow diagram of a method 1400, performed by the application 116, to visually indicate data items that have been extracted and categorised, according to an embodiment. Embodiments of the process of FIG. 14 are described below with reference to example embodiments illustrated in FIGS. 15, 16 and 17. FIGS. 15, 16 and 17 each illustrate a display object to which the application has highlighted data items that have been extracted and categorised from the display object, according to respective embodiments.

In operation 1402, the application presents a display object, or part thereof, to the user via the GUI 200. The display object depicts one or more alpha-numeric data items. The display object illustrated in FIGS. 15, 16 and 17 comprises a bank account statement, including data items describing a plurality of transactions performed on the bank account.

In operation 1404, the application performs an extraction process to extract one or more data items from the display object. The application stores the extracted data items in memory 130. The application may store each extracted data items in association with positional information indicating the position of the data item within the display object. The extracted data items in display object may be extracted by an automatic extraction process, or by the application extracting the data items in response to receiving a context annotation from a user. The application may store the alpha-numeric values associated with each of the extracted data items in memory.

In some embodiments, the application performs the extraction operation 1404 before performing the display operation 1402.

In operation 1406, the application categorises the extracted data items into one or more of the categories associated with the display object. For the example display object 1500, the application determines that the data categories comprise: date category; transaction description category; deposit amount category; and withdrawal amount category.

In operation 1408, the application applies one or more visual indicators to the display object to visually indicate the position of the one or more categorised data items in the display object. Each visual indicator may comprise a visual attribute that indicates the category to which the respective data item has been categorised.

### FIG. 15—Indicating Transactions

FIG. 15 illustrates a display object to which the application has applied visual indicators to indicate extracted data items associated with a transaction, according to an embodiment. Display object 1500 comprises, in tabular form at the bottom of the display object, a plurality of financial transactions. In this example, each financial transaction comprises a date, a description, and a withdrawal amount or a deposit amount. Data items 1502 (‘3 April’), 1504 (‘e-Transfer-Autodeposit’) and 1506 (′700.00′) are a subset of the data items of the display object 1500, and together describe a financial transaction.

In operation 1404, the application extracts at least data items 1502, 1504 and 1506. Other data items within the display object may be extracted in this operation. For example, the application may also extract the data item 1530, which indicates the opening date for the bank statement.

In operation 1406, the application attempts to categorise the extracted data items in accordance with a set of categories associated with the display object. Display object 1500 comprises a transaction summary for a bank account. In this example, the set of categories associated with display object 1500 comprises: date category; description category; deposit amount category and withdrawal amount category.

The application may apply a variety of techniques to determine a suitable category for a data item. In embodiments, the application receives, via the user interface, a context annotation associated with a data item. The context annotation may indicate a category for the data item.

In embodiments, the application may interpret the meaning of other data items in the display object to determine a suitable category for a data item. For example, the application may determine that the column heading suggests that data items located in that column comprise date category data items.

The application categorises: data item 1502 in the date category; data item 1504 in the description category; and data item 1506 in the deposit amount category.

In operation 1410, the application is configured to apply a visual indicator to an extracted and categorised data item in the display object, to provide an indication to the user of the category of the data item.

In this example, the application is configured to apply a visual indicator to collectively identify data items associated with a single transaction. Accordingly, in operation 1408, the application applies a visual indicator 1508 to data items 1502, 1504 and 1506 to indicate that each of these data items have been extracted by the application. The visual indicator 1508 comprises a rectangle encompassing the extracted data items 1502, 1504 and 1506.

Advantageously, the visual indicator 1510 indicates to the user that data items 1502, 1504 and 1506 have each been extracted. Furthermore, the visual indicator 1510 indicates that the application has categorised data items 1502, 1504 and 1506 and determined that these three data items are associated with the same financial transaction.

In other embodiments, the application may apply a separate visual indicator to each of data items 1502, 1504 and 1506. The separate visual indicators may share a common appearance to indicate to the user that these three data items are associated with the same transaction.

The application has also applied visual indicators 1518, 1520 and 1522 to indicate that the application extracted, categorised and associated with a transaction the data items encompassed by those respective visual indicators.

### Inferred Data Items

Visual indicator 1512 indicates that the application has extracted and categorised the data items encompassed by the rectangle. Notably, the format of the financial document depicted by display object 1500 does not include a date on each row of the transaction table. The application may be configured to infer, from the date included in the above row, that the date for transaction is also ‘3 April’.

In some embodiments, the application may be configured to display an inferred data item on the display object. For example, the application may be configured to display the inferred date ‘3 April’ 1514 in the display object. Advantageously, the user may view the displayed inferred data item to determine the accuracy of the application's inference.

### Not Extracted or not Categorised

In some situations, the application is unable to successfully extract a data item within a display object. Some of the transactions depicted in display object 1500 comprise a transaction description that is presented in two rows. In the example of FIG. 15, the application was unable to successfully extract the transaction description. Accordingly, the application has not applied a visual indicator to the data item 1516.

In some embodiments, in response to seeing the absence of a visual indicator applied to data item 1516, a user may manually enter the alpha-numeric value ‘Online Banking payment—1602 RBC MASTERCARD’ into the application.

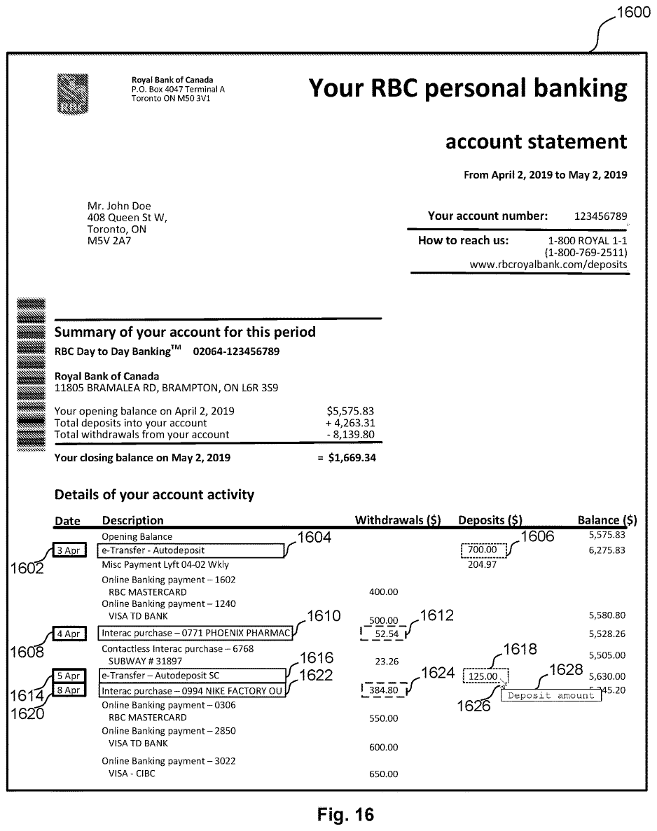

### FIG. 16—Display Categorisation

FIG. 16 illustrates a display object to which the application has applied visual indicators to indicate the categories of extracted data items, according to an embodiment. The application has applied visual indicators with different visual features to indicate respective different categories to which the application has categorised the extracted data items.

For example, the date data items 1602, 1608, 1614 and 1620 are encompassed by a thick-lined rectangle. Data items that have been extracted, and categorised as transaction descriptions (e.g., data items 1604, 1610, 1616 and 1622) are encompassed by a thin-lined rectangle, and data items that have been extracted and categorised as deposit amounts (e.g., data items 1606 and 1618) are encompassed by a dotted-lined rectangle.

In embodiments, the application may apply visual indicators that differ in shape, colour or another visual attribute to distinguish between the categories assigned to the extracted data items.

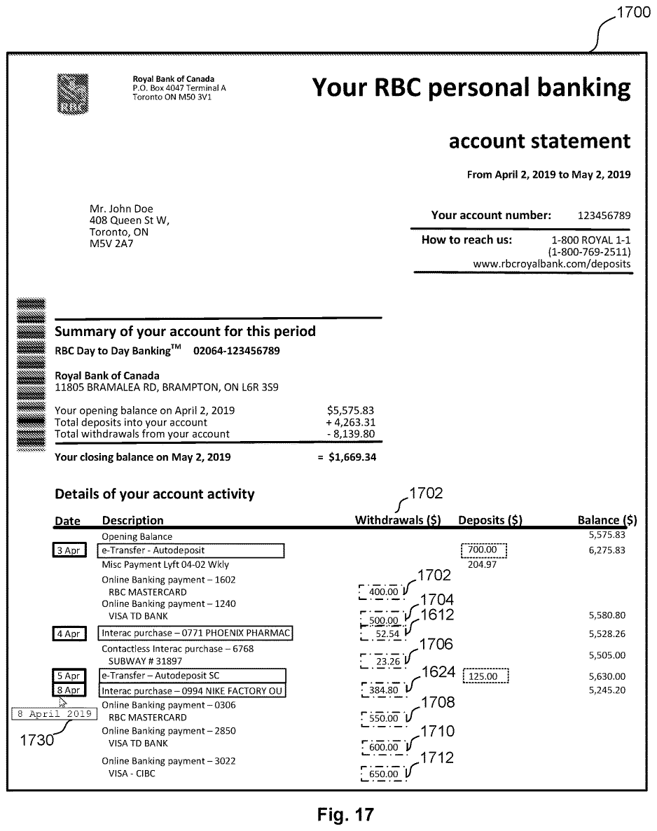

In the example illustrated in FIG. 17, the application is also configured to visually indicate extracted data items that the application has not been able to categorise. The application was unable to determine that data items 1612 and 1624 may be categorised as withdrawal amounts. Accordingly, the application has indicated that these extracted data items are not categorised by encompassing each of those data items with a dashed-line rectangle.

In some embodiments, in response to the application receiving, from a user via the GUI 200, a selection of a displayed data item, the application displays an indication of a category allocated to that data item. The category may be allocated by the application in response to receiving a context annotation from the user. The category may be allocated by the application in response to performing an automatic categorisation process.

The selection of the displayed data item by the user may comprise one or more of: a mouse click on the data item in the display object; a mouse-over of the data item in the display object; a selection of the data item as displayed on a touch screen display; a selection of the data item via a peripheral device, such as a keyboard.

In the example illustrated in FIG. 16, the application is configured to display a mouse pointer tag 1628 indicating the assigned category of the data item in response to the mouse pointer 1626 hovering over the data item 1618.

Advantageously, the visual indicators communicate to a user how the data items have been categorised by the application. The user may apply context annotations to correct an incorrect categorisation by the application.

### FIG. 17—Applying Context Annotations

In some embodiments, in response to seeing the absence of a visual indicator applied to data item 1516, a user may apply a context annotation to indicate a category for the data item. With reference to the process illustrated in FIG. 14, in operation 1412, the application is configured to receive a context annotation, via the user interface, from the user. The application is further configured to determine a category associated with the context annotation applied by the user and determine the data item(s) annotated by the context annotation. The application is configured to categorise the annotated data item(s) in accordance with the category associated with the context annotation. In some embodiments, the application performs process 300 to receive and process the context annotation.

FIG. 17 illustrates a display object to which the application has applied visual indicators to indicate the categories of extracted data items, according to an embodiment. The application has categorised the extracted data items in response to the user applying a context annotation to the data items to indicate the category of the data items. In particular, the user has applied a context annotation to the data item within the withdrawal amount column 1720 and indicated that the data items in that column are withdrawal amounts.

In response to the user applying the context annotation, the application has extracted the data items in column 1720 and categorised them as withdrawal amounts. The application has applied visual indicators 1702, 1704, 1706, 1708, 1710 and 1712 to indicate the withdrawal amount category. Furthermore, the application has altered the appearance of visual indicators to indicate that these data items 1612 and 1624 are no longer uncategorised, and they have been categorised as withdrawal amounts.

The application may be configured to visually indicate the alpha-numeric data determined by the application during the extraction operation 1404. The application may be configured to visually indicate the alpha-numeric data determined by the application in response to the user selecting the data item. With reference to the example illustrated in FIG. 17, the application displays mouse pointer tag 1730 indicating the alpha-numeric data determined by the application for data item ‘8 April’ in response to the mouse pointer hovering over the data item ‘8 April’. Notably, the application has normalised the date to expand the month name and to include a year. The application may infer the year based on year information provided elsewhere in the display object.

### Rows and Columns

Examples described herein and illustrated in the figures comprise data items which are arranged such that the data items that are associated with a single transaction are arranged in a horizontal row of a tabular form. It is to be understood that in embodiments, data items that form a set of associated data items (such as data items that describe a financial transaction, or an invoice item) may be arrange in either rows or columns, and that a single display object may comprise sets of associated data items arranged in rows and sets of associated data items arranged in columns. The methods and systems described herein may be applied in any of these circumstances.

It will be appreciated by persons skilled in the art that numerous variations and/or modifications may be made to the above-described embodiments, without departing from the broad general scope of the present disclosure. Furthermore, it will be appreciated by persons skilled in the art that embodiments disclosed herein can be combined with one or more other embodiment disclosed herein, without departing from the broad general scope of the present disclosure. The present embodiments are, therefore, to be considered in all respects as illustrative and not restrictive.

References herein to software or executable instructions are to be understood as referring to executable instructions stored in volatile or non-volatile memory. The memory can include any data storage device that can store data which can thereafter be read by a processor, such as a non-transitory storage medium. Examples of memory include read-only memory (ROM), random-access memory (RAM), magnetic tape, optical data storage device, flash storage devices, or any other suitable storage devices.

References herein to a ‘first’, a ‘second’ and a ‘third’ etc. instances of an entity or operation, are used to provide a distinction or differentiation between different instances of an entity or operation, or different iterations of an entity or operation, and are not intended to imply an order, ranking or preference.

1. A method, implemented by computer, comprising:
presenting, on a display device, a user interface;
presenting, in the user interface, a display object comprising a visual representation of a plurality of data items, the plurality of data items being arranged in a tabular form;
in response to a user input, received via the user interface, applying a context annotation to the display object;
determining, based on the context annotation, at least one selected data item of the plurality of data items;
determining a first data category associated with the selected data item;
determining, based on a position of the selected data item in the tabular form, a second data item of the plurality of data items; and
associating a second data category to the second data item, based on the first data category.

2. The method of claim 1, wherein determining at least one selected data item of the plurality of data items comprises:
determining a position of the context annotation on the display object; and
selecting the at least one selected data item based on the position of the context annotation on the display object.

3. The method of claim 1, wherein determining at least one selected data item of the plurality of data items comprises determining a distance between the context annotation and the selected data item.

4. The method of claim 1, wherein the context annotation:
at least partially intersects the at least one selected data item in the visual representation of the plurality of data items; and/or
encompasses, or substantially encompasses the at least one selected data item in the visual representation of the plurality of data items.

5. The method of claim 1, wherein determining a second data item of the plurality of data items comprises:
determining a row of the tabular form associated with the selected data item; and
selecting the second data item from a set of data items positioned in the row.

6. The method of claim 1, wherein determining a second data item of the plurality of data items comprises:
determining a column of the tabular form associated with the selected data item; and
selecting the second data item from a set of data items positioned in the column.

7. The method of claim 1, further comprising:
visually annotating the display object with a categorisation indication to indicate a data categorisation for the selected data item.

8. The method of claim 7, wherein the categorisation indication comprises:
a continuous or non-continuous line spatially associated with the selected data item;
a visual mark spatially associated with the selected data item; and/or
a visual effect applied to the selected data item.

9. The method of claim 1, further comprising:
in response to a second user input, received via the user interface, applying a second context annotation to the display object;
determining, based on the second context annotation, a third selected data item of the plurality of data items; and
determining a third data category associated with the third selected data item,
wherein associating the second data category to the second data item comprises, associating the second data category to the second data item based on the first data category and the third data category.

10. (canceled)

11. The method of claim 1, further comprising:
determining, by a character recognition module the plurality of data items from the display object; and
determining, by the character recognition module, machine-encoded text for each data item of the plurality of data items.

12. (canceled)

13. The method of claim 1, further comprising:
determining a tabular form of the plurality of data items,
wherein determining a tabular form comprises, for each data item of the plurality of data items, determining a row and a column associated with the data item.

14. (canceled)

15. The method of claim 1, further comprising annotating the display object with a tabular form indication to visually indicate the tabular form of the plurality of data items.

16. (canceled)

17. The method of claim 15, further comprising, in response to receiving a user input indicating an adjustment to the tabular form:
determining an adjusted tabular form; and
annotating the display object to visually indicate the adjusted tabular form.

18. The method of claim 1, wherein the context annotation spatially intersects the selected data item on the visual representation of a plurality of data items.

19. The method of claim 1, wherein the context annotation comprises:
a continuous or non-continuous line;
a continuous or non-continuous perimeter of a two-dimensional shape;
a continuous or non-continuous line that encompasses the visual representation of one or more data items of the plurality of data items; and/or
a continuous or non-continuous line that substantially encompasses the visual representation of one or more data items of the plurality of data items.

20. The method of claim 1, wherein the first data category comprises a user-selected data category.

21. The method of claim 1, further comprising, providing, via the user interface, a prompt to prompt the user to annotate the display object in accordance with the first data category.

22. (canceled)

23. (canceled)

24. The method of claim 1, wherein the second data item comprises a plurality of second data items, and wherein the plurality of second data items is positioned within a column of the tabular form of the plurality of data items

25. (canceled)

26. (canceled)

27. (canceled)

28. (canceled)

29. (canceled)

30. A system comprising:
one or more processors; and
memory comprising computer executable instructions, which when executed by the one or more processors, individually or in combination, cause the system to perform operations including:
presenting, on a display device, a user interface;
presenting, in the user interface, a display object comprising a visual representation of a plurality of data items, the plurality of data items being arranged in a tabular form;
in response to a user input, received via the user interface, applying a context annotation to the display object;
determining, based on the context annotation, at least one selected data item of the plurality of data items;
determining a first data category associated with the selected data item;
determining, based on a position of the selected data item in the tabular form, a second data item of the plurality of data items; and
associating a second data category to the second data item, based on the first data category.

31. A non-transitory machine-readable storage medium storing instructions that, when executed by one or more processors, individually or in combination, cause the one or more processors to perform operations including:
presenting, on a display device, a user interface;
presenting, in the user interface, a display object comprising a visual representation of a plurality of data items, the plurality of data items being arranged in a tabular form;
in response to a user input, received via the user interface, applying a context annotation to the display object;
determining, based on the context annotation, at least one selected data item of the plurality of data items;
determining a first data category associated with the selected data item;
determining, based on a position of the selected data item in the tabular form, a second data item of the plurality of data items; and
associating a second data category to the second data item, based on the first data category.

32.-47. (canceled)
